(19) United States
(12) Patent Application Publication
(10) Pub. No.: US 2004/0173425 A1
(43) Pub. Date: Sep. 9, 2004

(54) Hydraulic shock absorber

(76) Inventors: Minoru Shinozuka, Saitama (JP); Takeshi Murata, Saitama (JP)

Correspondence Address: ORUM & ROTH, 53 W. JACKSON BLVD, CHICAGO, IL, 60604, US

(21) Appl. No.: 10/639,878

(22) Filed: Aug. 13, 2003

(30) Foreign Application Priority Data
Mar. 6, 2003 (JP) 2003-060578

(51) Int. Cl. F16F 9/00

(52) U.S. Cl. 188/322.19

(57) ABSTRACT

A collapsible upright wall extends the height of the sides on the load hauling box on a truck. The collapsible upright wall comprises a fabric which when vertically stretched provides adequate resistance to substantial lateral load. A method of increasing the volumetric capacity of the box on a truck comprises the steps of: a) providing a rectangular frame above, and dimensioned to seat adjacent to an open top side portion of the load hauling box on the truck; b) providing a substantial lift mechanism to uniformly lift the rectangular frame above the box; and, c) providing and attaching an elongate strip of fabric having a top elongate side portion peripherally attached to the rectangular frame, and a bottom elongate side portion peripherally attached to the open top side portion of the box. Then when the rectangular frame is lifted to an upper operable position the fabric is stretched taut and is thereby able to sustain significant lateral load.

### BACKGROUND OF THE INVENTION

1. Field of the Invention

The present invention relates to a hydraulic shock absorber.

2. Description of the Related Art

A hydraulic shock absorber is provided with an axle side mounting portion in a lower portion of a damper tube, and with a vehicle body side mounting portion in a damper rod. The hydraulic shock absorber absorbs an impact applied from a road surface by a suspension spring interposed between the damper tube and the damper rod, and damps the expansion and compression vibration of a suspension spring by a damping apparatus installed in the damper tube.

In a conventional hydraulic shock absorber, the vehicle body side mounting portion is held by a mount rubber supported to the damper rod. The mount rubber is supported by a mount support collar provided in the damper rod to be mounted to the damper rod. A fixing configuration of the mount support collar to the damper rod is a configuration described in Japanese Utility Model Publication No. 61-12439 (patent document 1). In this configuration, an outer diameter of a mounting portion in the damper rod is smaller than an outer diameter of a lower portion side with respect to the mounting portion. The mount support collar is mounted on a large diameter step portion provided in a lower portion of a small diameter mounting portion which is held.

Further, another fixing configuration of the mount support collar to the damper rod is also a configuration described in patent document 1. In this configuration, a C-ring is engaged with a groove provided in an outer periphery of the damper rod, and the mount support collar is mounted on the C-ring which is held.

However, in the configuration in which the mount support collar is mounted on the step portion provided in the damper rod which is held, the mounting portion in an upper side of the step portion in the damper rod is made small in diameter, whereby strength of the damper rod is lowered. For example, in the case that a 1 mm step portion is formed in a damper rod having an outer diameter 12.5 mm, the diameter of the damper mounting portion is 10 mm, and strength thereof is lowered.

In the configuration in which the mount support collar is mounted on the C-ring engaged with the groove provided in the damper rod which is held, the depth of the groove is sufficiently set at approximately 0.5 to 0.75 mm. In the damper rod having an outer diameter 12.5 mm, the groove diameter is about 11 mm, so that the strength of the damper rod is not substantially lowered. In this case, however, the strength of the C-ring holding the mount support collar against an axial load of the damper rod is law, and two parts comprising the C-ring and the collar are required, so that assembling work is increased.

### SUMMARY OF THE INVENTION

An object of the present invention is to securely fix a mount support collar to a damper rod against an axial load of the damper rod without reducing the strength of the damper rod, while reducing an assembling work involved in assembling the mount support collar to the damper rod.

The present invention provides a hydraulic shock absorber in which a mount support collar is fixed to a damper rod, configured such that a collar fixing groove is provided in an outer periphery of the damper rod, and the mount support collar is fixed to the collar fixing groove via a caulking.

### BRIEF DESCRIPTION OF THE DRAWINGS

The present invention will be more fully understood from the detailed description given below and from the accompanying drawings, which should not be taken to be a limitation on the invention, but are for explanation and understanding only.

The drawings:

FIG. 1 is a half cross sectional view showing a hydraulic shock absorber;

FIG. 2 is a cross sectional view showing a mounting arrangement of a mount to a damper rod;

FIG. 3 is a front elevational view showing the damper rod;

FIG. 4 is a cross sectional view showing a mount support collar; and

FIG. 5 is a half cross sectional view showing a caulking arrangement between the mount support collar and a rebound seat.

### DESCRIPTION OF THE PREFERRED EMBODIMENTS

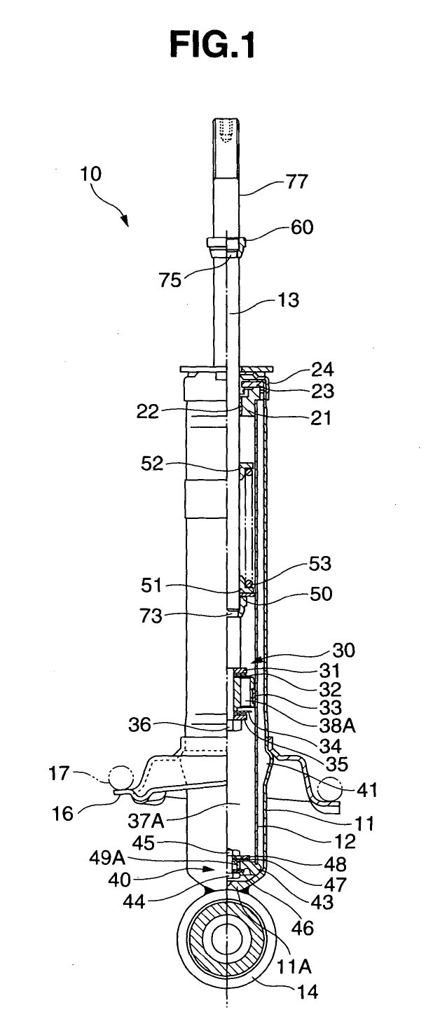

As shown in FIG. 1, a hydraulic shock absorber 10 is configured such that a cylinder 12 is built in a damper tube 11 to form a double tube. A damper rod 13 is inserted to the cylinder 12. An axle side mounting portion 14 constituted by an i-joint is provided in a lower portion of the damper tube 11, and a vehicle body side mounting portion 15 is provided in an upper portion of the damper rod 13, whereby the suspension apparatus of a vehicle is configured.

In the hydraulic shock absorber 10, a suspension spring 17 is interposed between a lower spring seat 16 in an outer periphery of the damper tube 11 and an upper spring seat (not shown) provided in the vehicle body side mounting portion 15 in an upper end portion of the damper rod 13.

In the hydraulic shock absorber 10, a rod guide 21 for the damper rod 13 inserted to the cylinder 12, a bush 22 and an oil seal 23 are fixed to be clamped between an upper end caulked portion 24 of the damper tube 11 and an upper end of the cylinder 12.

The hydraulic shock absorber 10 has a piston valve apparatus 30 and a bottom valve apparatus 40. The hydraulic shock absorber 10 damps the expansion and compression vibration of the damper rod 13 caused by an absorption of the impact force by the suspension spring 17, on the basis of a damping force generated by the piston valve apparatus 30 and the bottom valve apparatus 40.

Piston Valve Apparatus 30:

The piston valve apparatus 30 is configured such that a valve stopper 31, a check valve 32, a piston 33, a disc valve 34 and a valve stopper 35 are attached to a damper rod 13, and are fixed by a piston lock nut 36.

During compression, oil in a piston side oil chamber 37A passes through a compression side flow passage 38A of the piston 33, flexibly deforms the check valve 32 to open, and is introduced to a rod side oil chamber 37B. During expansion, oil in a rod side oil chamber 37B passes through an expansion side flow passage 38B (not shown) of the piston 33, flexibly deforms the disc valve 34 to open, is introduced to the piston side oil chamber 37A, and generates an expansion side damping force.

Bottom Valve Apparatus 40:

In the hydraulic shock absorber 10, a gap between the damper tube 11 and the cylinder 12 is formed as a reservoir chamber 41, and an inner portion of the reservoir chamber 41 is sectioned into an oil chamber and a gas chamber. Further, in the bottom valve apparatus 40, a bottom portion 11A of the damper tube 11 is closed by a spinning operation. A bottom piece 43 separating the piston side oil chamber 37A in an inner portion of the cylinder 12 from the reservoir chamber 41 is arranged in a lower end portion of the cylinder 12. The piston side oil chamber 37A and the reservoir chamber 41 may be in fluid communication via a flow passage (not shown) provided in the bottom piece 43. A bolt 44 and a nut 45 are fastened to the bottom piece 43, and a disc valve 46, the bottom piece 43, a check valve 47 and a valve stopper 48 are interposed between the bolt 44 and the nut 45.

During compression, oil at an amount corresponding to a forward moving volume of the damper rod 13 moving forward to the cylinder 12 passes through a compression side flow passage 49A of the bottom piece 43 from the piston side oil chamber 37A, flexibly deforms the disc valve 46 to open, is pushed out to the reservoir chamber 41, and obtains a compression side damping force. During expansion, oil in an amount corresponding to a backward moving volume of the damper rod 13 moving backward from the cylinder 12 pushes open the check valve 47, and is re-supplied from the reservoir chamber 41 to the piston side oil chamber 37A via an expansion side flow passage 49B (not shown) of the bottom piece 43.

In the hydraulic shock absorber 10, a rebound spring 53, which is compression deformed when the damper rod 13 is fully expanded in the most expanded state of the hydraulic shock absorber 10, is interposed between a first collar 51 and a second collar 52. Around the damper rod 13 positioned in the rod side oil chamber 37B of the cylinder 12, the first collar 51 is fixed to a side of the piston 33 (a lower side of the damper rod 13), and a second collar 52 is loosely fitted to a side of the rod guide 21 (an upper side of the damper rod 13). A rebound seat 50 is fixed to an outer periphery of a portion inserted to the cylinder 12 in the damper rod 13 in the manner mentioned below, and the first collar 51 loaded in a lower end portion of the rebound spring 53 is mounted on the rebound seat 50 to be supported.

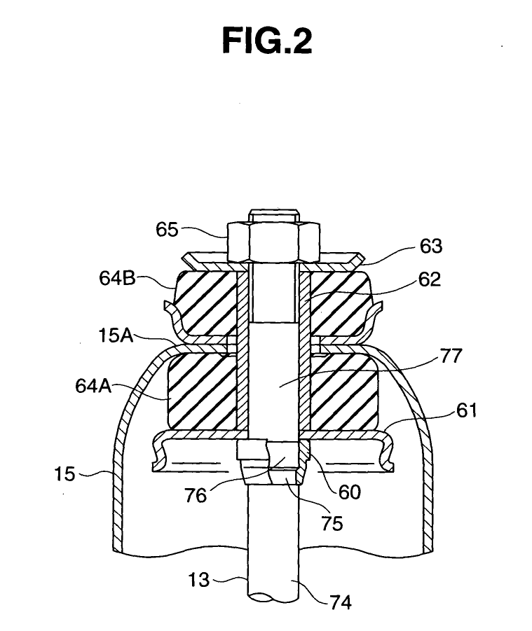

In the hydraulic shock absorber 10, a mounting configuration of the vehicle body side mounting portion 15 to the upper portion of the damper rod 13 is configured as follows (FIG. 2). A mount support collar 60 is fixed to an outer periphery protruding from the cylinder 12 of the damper rod 13 in the manner mentioned below. A receiving seat 61, a joint collar 62, and a receiving seat 63 which are inserted to a mount mounting portion 77, mentioned below, of the damper rod 13 are mounted in this order and supported on the mount support collar 60. Mount rubbers 64A and 64B are provided between the receiving seat 61 and the receiving seat 63, and a mount fixing nut 65 is screwed into an upper end portion of the damper rod 13, thereby clamping the base end portion 15A of the vehicle body side mounting portion 15 between the mount rubbers 64A and 64B.

Accordingly, the rebound seat 50 and the mount support collar 60 mentioned above are fixed to the damper rod 13 in the following manner.

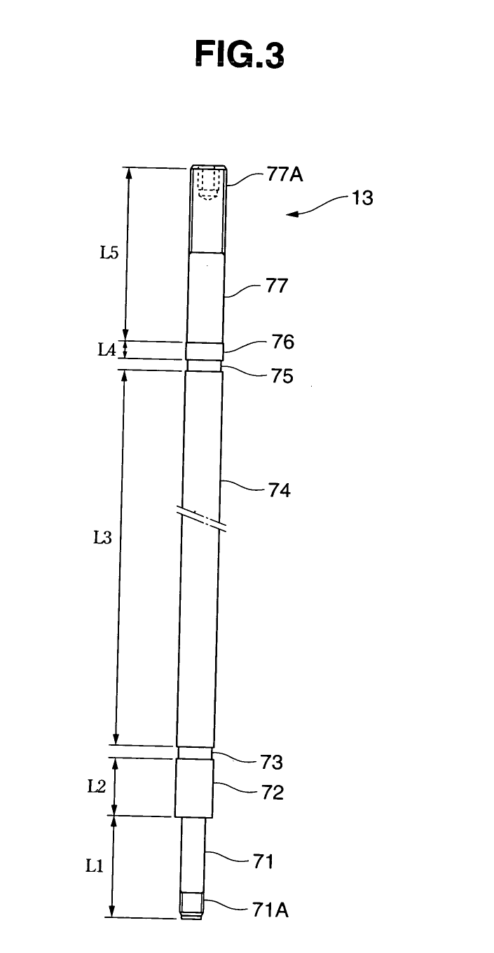

In the damper rod 13, as shown in FIG. 3, a lower end portion having a length L1 is formed as a small-diameter piston mounting portion 71 (for example, having a diameter 8 mm), and a screw portion 71A (for example, M8) for the piston fixing nut 36 is provided in a leading end portion of the piston mounting portion 71. The damper rod 13 is provided with a lower shaft portion 72 (for example, having a diameter 12.5 mm) having a length L2 on the piston mounting portion 71 and may be continuously arranged via a step portion. The damper rod 13 may be provided with a seat fixing groove 73 (for example, having a groove diameter 11.5 mm) on the lower shaft portion 72, may be provided with an intermediate shaft portion 74 (for example, having a diameter 12.5 mm) having a length L3 on the seat fixing groove 73, may be provided with a collar fixing groove 75 (for example, having a groove diameter 11 mm) on the intermediate shaft portion 74, and may be provided with an upper shaft portion 76 (for example, having a diameter 12.5 mm) having a length L4 on the collar fixing groove 75. The damper rod 13 may be provided with a mount mounting portion 77 (for example, having a diameter 12 mm) having the same diameter as that of the upper shaft portion 76 and a length L5 on the upper shaft portion 76, and may be provided with a screw portion 77A (for example, M12) for the mount fixing nut 65 in a leading end portion of the mount mounting portion 77.

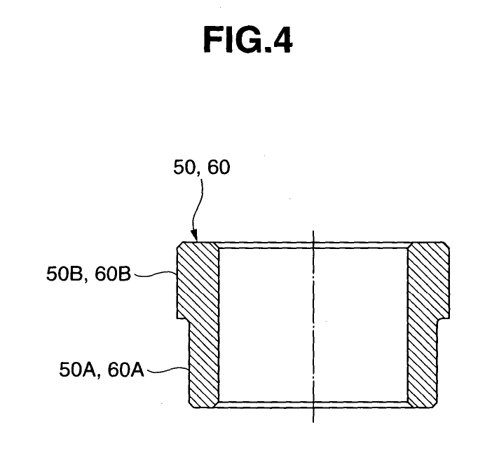

The rebound seat 50 and the mount support collar 60 are formed in an identical flanged circular tube shape as shown in FIG. 4.

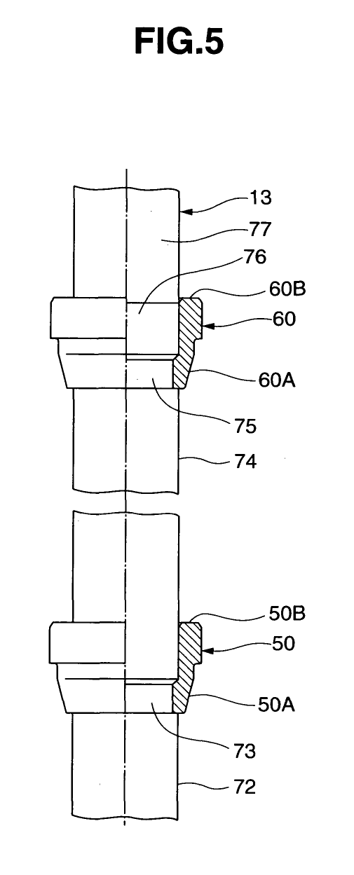

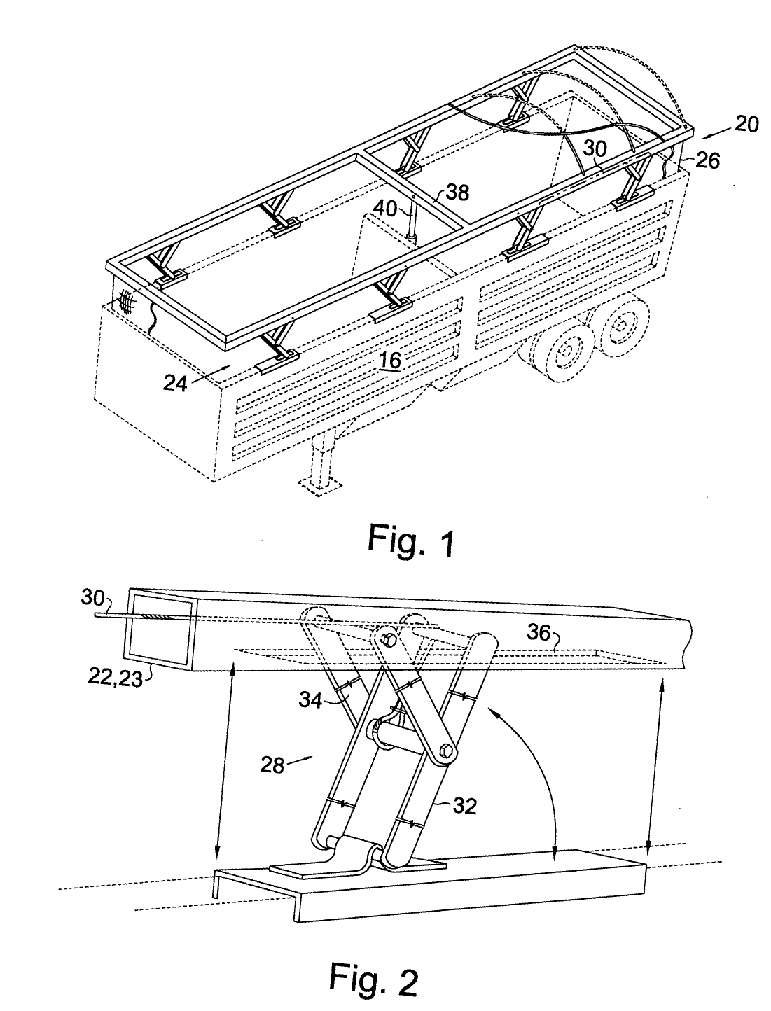

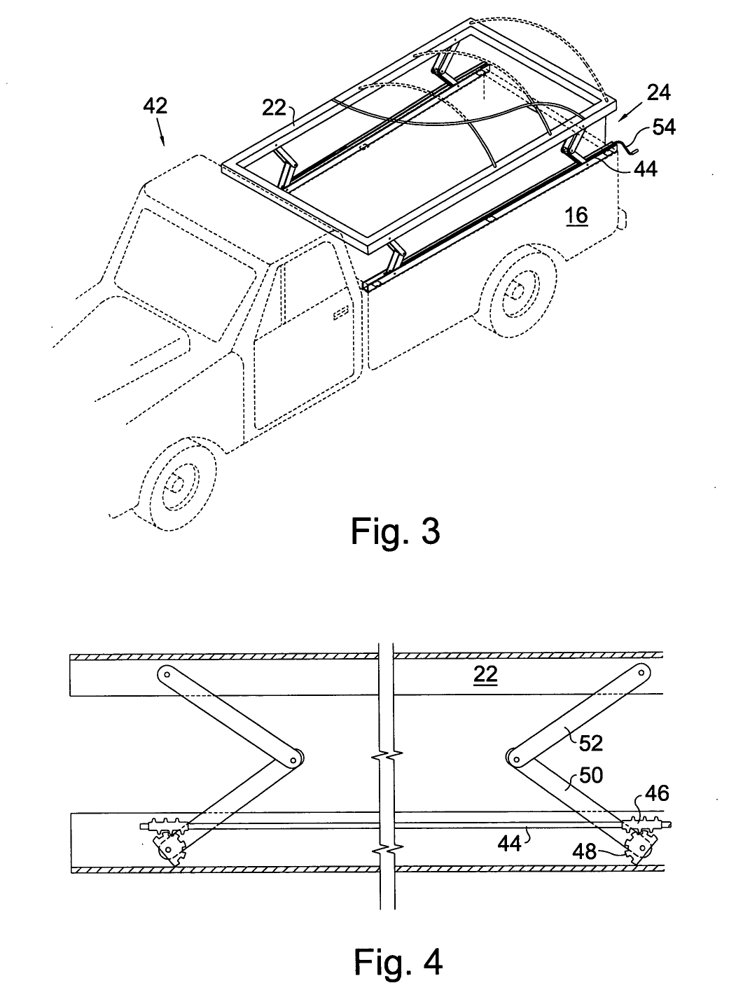

The rebound seat 50 is configured, as shown in FIG. 5, such that a circular tube portion 50A is fixed to the seat fixing groove 73 of the damper rod 13 by caulking. The first collar 51 for the rebound spring 53 is mounted on an upper end surface of a flange portion 50B to be supported. The seat fixing groove 73 can be in the form of a triangular groove, a trapezoidal groove or the like. The circular tube portion 50A of the rebound seat 50 may be caulked in an entire periphery or may be partly caulked in a plurality of positions such as four or eight positions in a peripheral direction.

In the mount support collar 60, as shown in FIG. 5, a circular tube portion 60A is fixed to the collar fixing groove 75 of the damper rod 13 by a caulking operation. The receiving seat 61 for the mount rubbers 64A and 64B of the vehicle body side mounting portion 15 is mounted on the upper end surface of the flange portion 60B to be supported. The collar fixing groove 75 can be in the form of a triangular groove, a trapezoidal groove or the like. The circular tube portion 60A of the mount support seat 60 may be caulked along an entire periphery or may be partly caulked in a plurality of positions such as four or eight positions in a peripheral direction.

The circular tube portion 60A of the mount support collar 60 is fixed to the collar fixing groove 75 of the damper rod 13 by a caulking operation, and is attached to the upper shaft portion 76. Accordingly, in the damper rod 13, outer diameters of upper and lower portions (the intermediate shaft portion 74 and the upper shaft portion 76) clamping the collar fixing groove 75 in an axial direction are set to the same diameter (for example, the diameter 12.5 mm. The upper portion of the collar fixing groove 75 and the upper shaft portion 76 in the damper rod 13 are set to a mounting portion 77, and a threaded portion for the mount fixing nut 65 is provided in an upper end portion of the mounting portion 77.

An assembling procedure of the hydraulic shock absorber 10 is as follows.

(1) The piston 33, the rebound seat 50 and the like are provided from the lower portion to the intermediate portion of the damper rod 13, and the rebound spring 53 and the like are loaded and inserted to the cylinder 12.

(2) The rod guide 21, the oil seal 23 and the like are assembled in the upper portion of the damper tube 11 and the cylinder 12, whereby the upper end caulked portion 24 of the damper tube 11 is provided.

(3) The mount support collar 60 and the like are assembled in the upper portion of the damper rod 13, whereby the vehicle body side mounting portion 15 is provided.

In accordance with the present embodiment, the following operational advantages can be obtained.

(1) A depth of the collar fixing groove 75 required for caulking the mount support collar 60 is set to approximately 0.5 to 0.75 mm, and in the damper rod having the outer diameter 12.5 mm, the groove diameter is approximately 11 mm and not to be minimized, so that the strength of the damper rod 13 is not reduced.

(2) Since the mount support collar 60 is fixed to the collar fixing groove 75 by caulking, it is possible to firmly and securely fix the mount support collar 60 against the axial load of the damper rod 13, with the result such that reliability is improved.

(3) Since the mount support collar 60 is directly assembled in the damper rod 13, the number of parts is not increased and assembling work can be reduced.

(4) When conveying the mount support collar 60 in a sub-assembly state in which the mount support collar 60 is assembled to the damper rod 13, it does not require any special precautions to prevent the mount support collar 60 from coming off.

(5) Since the outer diameters of the upper and lower portions (the intermediate shaft portion 74 and the upper shaft portion 76) clamping the collar fixing groove 75 of the damper rod 13 are set to the same diameter (for example, 12.5 mm), it is not necessary to arrange the collar fixing groove 75 and the mount mounting portion 77 in the upper portion of the upper shaft portion 76 to be minimized in diameter and arranged in a stepped shape. Even in the case that the outer diameter of the damper rod 13 is small and the step portion for mounting the mount support collar 60 can not be formed, it is possible to securely fix the mount support collar 60. Although the present invention is particularly advantageous for the small-diameter damper rod 13, this invention can be applied without being limited to the damper rod 13 having a small diameter. When the outer diameter of the damper rod 13 is close to the thread diameter of the mounting fixing nut 65 (for example, when the mounting fixing nut 65 of M12 mm is employed with respect to the damper rod 13 having an outer diameter 12.5 mm), the step portion is not provided in the damper rod 13. This arrangement is particularly advantageous.

(6) The parts can be used interchangeably and the cost can be reduced by forming the mount support collar 60 and the rebound seat 50 in an identical shape. At this time, it is possible to use a caulking machine of the rebound seat 50 interchangeably with a caulking machine of the mount support collar 60, and it is thereby possible to simplify the equipment.

As heretofore explained, embodiments of the present invention have been described in detail with reference to the drawings. However, the specific configurations of the present invention are not limited to the illustrated embodiments but those having a modification of the design within the range of the present claimed invention are also included in the present invention. For example, the hydraulic shock absorber according to the present invention can be applied to a front damper without being limited to the rear damper of the vehicle.

According to the present invention, it is possible to securely fix the mount support collar to the damper rod against the axial load of the damper rod without reducing the strength of the damper rod while reducing the assembling work, during assembly of the mount support collar to the damper rod.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A hydraulic shock absorber in which a mount support collar is fixed to a damper rod, wherein a collar fixing groove is disposed in an outer periphery of the damper rod, and the mount support collar is fixed to the collar fixing groove in accordance with a caulking arrangement.

2. A hydraulic shock absorber according to claim 1, wherein the damper rod is arranged such that outer diameters of upper and lower portions clamping the collar fixing groove in an axial direction are the same diameter, an upper portion of the collar fixing groove in the damper rod is set to a mount mounting portion, and a threaded portion is provided for a mount fixing nut in an upper end portion of the damper rod.

3. A hydraulic shock absorber according to claim 1, wherein a seat fixing groove is disposed in an outer periphery of the damper rod, a rebound seat is fixable to the seat fixing groove by caulking, and the rebound seat and the mount support collar are arranged in an identical shape.

4. A hydraulic shock absorber according to claim 2, wherein a seat fixing groove is disposed in an outer periphery of the damper rod, a rebound seat fixable to the seat fixing groove by caulking, and the rebound seat and the mount support collar are arranged in an identical shape.

5. A hydraulic shock absorber according to claim 1, wherein the mount support collar comprises a circular tube portion caulked and fixed to the collar fixing groove of the damper rod and a flange portion continuously disposed in an upper end of the circular tube portion, the mount support collar being arranged in a flanged circular tube shape.

6. A hydraulic shock absorber according to claim 2, wherein the mount support collar comprises a circular tube portion caulked and fixed to the collar fixing groove of the damper rod and a flange portion continuously disposed in an upper end of the circular tube portion, the mount support collar being arranged in a flanged circular tube shape.

7. A hydraulic shock absorber according to claim 1, wherein the collar fixing groove is a triangular groove.

8. A hydraulic shock absorber according to claim 1, wherein the collar fixing groove is a trapezoidal groove.

9. A hydraulic shock absorber according to claim 5, wherein the caulking to the collar fixing groove by the mount support collar comprises an entire periphery caulking of the circular tube portion of the mount support collar.

10. A hydraulic shock absorber according to claim 6, wherein the caulking to the collar fixing groove by the mount support collar comprises an entire periphery caulking of the circular tube portion of the mount support collar.

11. A hydraulic shock absorber according to claim 5, wherein the caulking to the collar fixing groove by the mount support collar comprises a partial caulking of a plurality of positions of the circular tube portion of the mount support collar.

12. A hydraulic shock absorber according to claim 6, wherein the caulking to the collar fixing groove by the mount support collar comprises a partial caulking of a plurality of positions of the circular tube portion of the mount support collar.

13. A hydraulic shock absorber according to claim 3, wherein the rebound seat comprises a circular tube portion caulked and fixed to the seat fixing groove of the damper rod and a flange portion continuously disposed in an upper end of the circular tube portion, and being arranged in a flanged circular tube shape.

14. A hydraulic shock absorber according to claim 4, wherein the rebound seat comprises a circular tube portion caulked and fixed to the seat fixing groove of the damper rod and a flange portion continuously disposed in an upper end of the circular tube portion, and being arranged in a flanged circular tube shape.

15. A hydraulic shock absorber according to claim 3, wherein the seat fixing groove is a triangular groove.

16. A hydraulic shock absorber according to claim 3, wherein the seat fixing groove is a trapezoidal groove.

17. A hydraulic shock absorber according to claim 13, wherein the caulking to the seat fixing groove by the rebound seat comprises an entire periphery caulking of the circular tube portion of the rebound seat.

18. A hydraulic shock absorber according to claim 14, wherein the caulking to the seat fixing groove by the rebound seat comprises an entire periphery caulking of the circular tube portion of the rebound seat.

19. A hydraulic shock absorber according to claim 13, wherein the caulking to the seat fixing groove by the rebound seat comprises a partial caulking of a plurality of positions of the circular tube portion of the rebound seat.

20. A hydraulic shock absorber according to claim 14, wherein the caulking to the seat fixing groove by the rebound seat comprises a partial caulking of a plurality of positions of the circular tube portion of the rebound seat.
